(19) United States
(12) Patent Application Publication
(10) Pub. No.: US 2023/0415352 A1
(43) Pub. Date: Dec. 28, 2023

(54) TEACHING SYSTEM FOR WORKPIECE AUTOMATIC CONVEYANCE DEVICE

(71) Applicant: FUJI CORPORATION, Chiryu (JP)

(72) Inventor: Tsukuru KODERA, Toyota-shi (JP)

(73) Assignee: FUJI CORPORATION, Chiryu (JP)

(21) Appl. No.: 18/249,393

(22) PCT Filed: Dec. 15, 2020
(86) PCT No.: PCT/JP2020/046710

§ 371 Date: Apr. 18, 2023

(51) Int. Cl. B25J 13/08; B25J 9/16

(52) U.S. Cl. CPC B25J 13/086; B25J 9/1612

(57) ABSTRACT

The teaching system for a workpiece automatic conveyance device is a teaching system for a workpiece automatic conveyance device that makes teaching easier, and delivers a workpiece gripped by a robot-side chuck configured in a robot hand to a partner device, the teaching system including a contact detection device provided in the robot hand and configured to detect contact at a predetermined portion with the partner device, and a control device configured to calculate a position of the robot hand during the contact based on a contact detection signal from the contact detection device.

### TECHNICAL FIELD

The present disclosure relates to a teaching system for performing teaching in a workpiece automatic conveyance device.

### BACKGROUND ART

In an articulated robot that performs predetermined work such as delivering a workpiece to a partner device, origin detection using an origin mark, a positioning pin, or the like is performed for each driving axis, as well as teaching for storing an operation according to a control program is performed. For example, in a case of a conveying robot, it is required to convey a workpiece to an accurate position by executing a stored control program. However, if an error occurs in the component accuracy of the robot or in the partner device that receives the workpiece, the work performed by the numerical control cannot be accurately performed. Therefore, although teaching has been conventionally performed, Patent Literature 1 discloses a teaching system for this purpose.

This conventional art is a teaching system of an articulated robot that moves a workpiece gripped by a chuck at a tip end to a target position. In this system, the position of the chuck and the position of the workpiece are roughly aligned, and the workpiece conveyed to a predetermined position is gripped by the chuck. At this time, if there is a deviation at the center positions of the chuck and the workpiece, the floating body on the chuck side moves, so that the center positions of the chuck and the workpiece coincide with each other. The position of the chuck is detected by the sensor, and an actual chuck position is calculated in the calculating section based on the position data.

### PATENT LITERATURE

Patent Literature 1: JP-A-H7-75986

### BRIEF SUMMARY

### Technical Problem

The above-described conventional teaching system is to provide a floating mechanism in an articulated robot, and requires a special structure for the robot itself. Therefore, since the special structure is added, the cost of the articulated robot increases. In addition, the floating mechanism makes the articulated robot structurally weak, which can easily cause failure. Therefore, the teaching may be performed by an operator without adding such a special structure. For example, in a case where the deviation occurs at the center position, since the conveyance robot side is pulled when delivering the workpiece, adjustment for aligning the center position is performed to eliminate the deviation by the operator who visually checks the change. However, although such adjustment has no structural problem, the skill level of the operator greatly affects in order to accurately perform the adjustment, so that there would be a large difference in the number of steps and accuracy depending on the operator.

Accordingly, it is an object of the present disclosure to provide a teaching system of a workpiece automatic conveyance device that can be performed more easily in order to solve the above-mentioned problems.

### Solution to Problem

In one aspect of the present disclosure, a teaching system for a workpiece automatic conveyance device configured to deliver a workpiece gripped by a robot-side chuck configured in a robot hand to a partner device includes a contact detection device provided in the robot hand and configured to detect contact at a predetermined portion with the partner device, and a control device configured to calculate a position of the robot hand during the contact based on a contact detection signal from the contact detection device.

### Advantageous Effects

With the above configuration, since the contact detection device such as a touch probe provided in the robot hand detects the contact at a predetermined portion with the partner device, and thus the control device calculates the position of the robot hand during the contact based on the contact detection signal, it is possible to perform the teaching more easily. Further, with such a configuration, a complicated structure as in the conventional art is not necessary, and differences in accuracy and work time depending on the skill level of the operator do not occur.

### BRIEF DESCRIPTION OF DRAWINGS

FIG. 1 is a perspective view illustrating a main structure of a multifunctional machining machine.

FIG. 2 is a side view of the multifunctional machining machine including a workpiece automatic conveyance device and an automatic tool exchanging device.

FIG. 3 is a view conceptually illustrating a control system of the multifunctional machining machine.

FIG. 4 is a perspective view illustrating a lifting and lowering arm portion of the workpiece automatic conveyance device.

FIG. 5 is a view illustrating a work state of teaching as viewed from the above in an X-axis direction.

FIG. 6 is a view illustrating a work state of teaching in which a workpiece is gripped on one side as viewed from the above in the X-axis direction.

FIG. 7 is a view illustrating a work state of teaching in a depth direction as viewed from the above in the X-axis direction.

### DESCRIPTION OF EMBODIMENTS

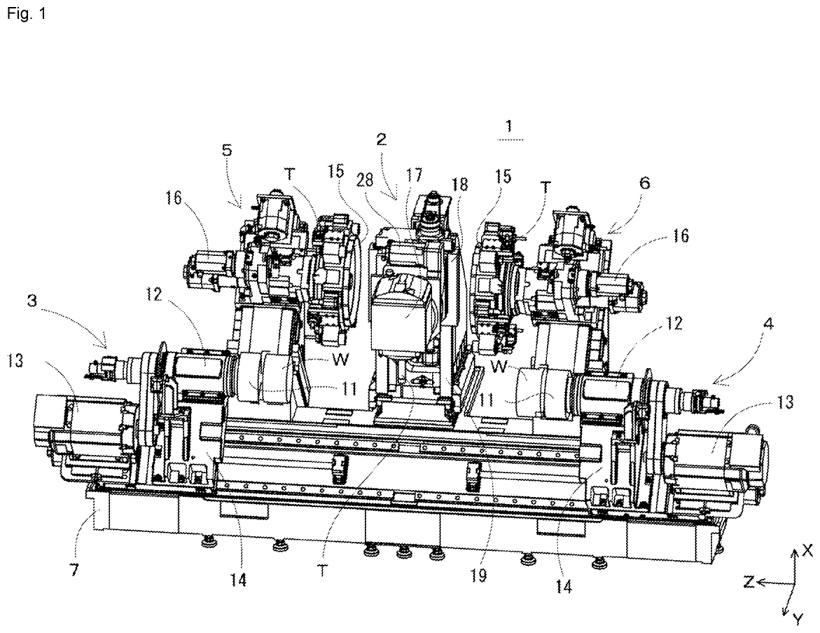

One embodiment of a teaching system of a workpiece automatic conveyance device according to the present disclosure will be described below with reference to the drawings. First, the workpiece automatic conveyance device of the present embodiment is incorporated in a multifunctional machining machine, and FIG. 1 is a perspective view illustrating a main structure of the multifunctional machining machine. Multifunctional machining machine 1 is a machine tool having various machining devices to have both functions of an NC lathe and a machining center. Specifically, multifunctional machining machine 1 is an opposed biaxial lathe in which first workpiece main spindle device 3 and second workpiece main spindle device 4 for gripping workpiece W, and first turret device 5 and second turret device 6 having multiple tools T are disposed symmetrically with each other relative to a left-right direction, and in addition, tool main spindle device 2 is provided at a center of a machine body.

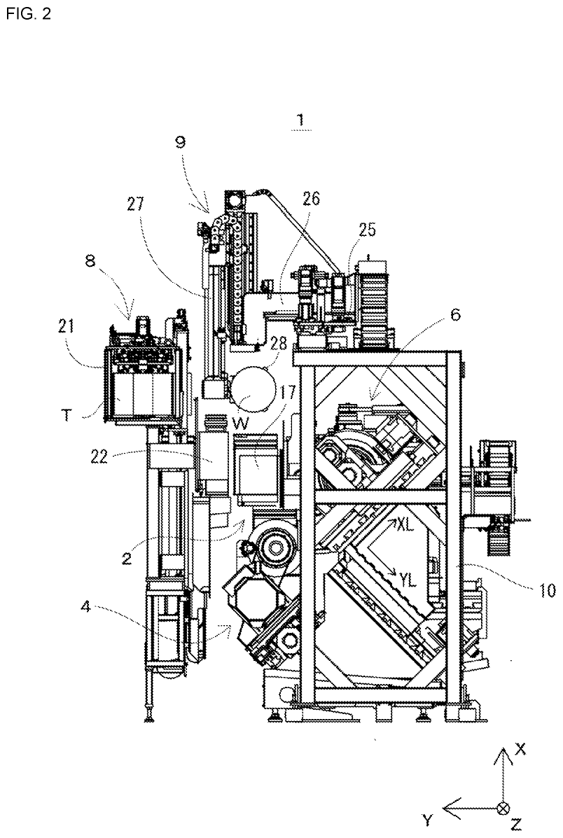

Main spindle-side chuck 11 is assembled to the spindle of main spindle stand 12, and a pair of first and second workpiece main spindle devices 3 and 4 rotate by the driving of spindle motor 13, respectively, so that gripped workpiece W is subjected to phase determination during machining and rotation at a predetermined speed. Main spindle stand 12 and spindle motor 13 are mounted on main spindle slide 14, and are configured to move on bed 7 in a Z-axis direction which is a machine body width direction (an axial direction of the spindle of main spindle stand 12). In addition, in first turret device 5 and second turret device 6, pivot indexing of tool T (turret tool) mounted on turret 15 is performed by rotation control of indexing servo motor 16. In order to move tool T to a machining position for workpiece W, a drive mechanism is provided such that turret 15 moves in two directions, that is, a YL-axis in a front-rear direction of the machine body and an XL-axis in an up-down direction of the machine body, which are orthogonal to a Z-axis (refer to FIG. 2).

Tool main spindle device 2 has a built-in main spindle head 17 in which a main spindle servo motor and a tool spindle are incorporated, and is mounted on main spindle slide 18 that is movable in an X-axis direction vertical to the front and rear of the machine body, and main spindle slide 18 is mounted on base slide 19 that is movable in a Y-axis direction horizontal to the front and rear of the machine body. Main spindle head 17 is configured such that tool T (main spindle head tool) is replaced according to the machining content and rotates around a B-axis in parallel with the Y-axis. The YL-axis and the XL-axis, which are the movement directions of turret 15 described above, are inclined by 45 degrees with respect to the Y-axis and the X-axis as illustrated in FIG. 2.

FIG. 2 is a side view of multifunctional machining machine 1 to which the workpiece automatic conveyance device and the automatic tool exchanging device are added. In multifunctional machining machine 1, automatic tool exchanging device 8 for automatically exchanging tool T (main spindle head tool) with respect to tool main spindle device 2 is provided at a center front part of the machine body. In automatic tool exchanging device 8, tool magazine 21 in which multiple tools T are housed is provided at an upper portion, so that the tool exchange is performed by tool changer 22 facing main spindle head 17. A shift mechanism for moving a tool is provided between main spindle head 17 and tool changer 22.

Multifunctional machining machine 1 is provided with workpiece automatic conveyance device 9 for performing supplying and discharging workpiece W to and from first and second workpiece main spindle devices 3 and 4. In multifunctional machining machine 1, frame structure 10 having a turret shape is assembled on bed 7, and workpiece automatic conveyance device 9 is a gantry-type conveyance device mounted on frame structure 10. Workpiece automatic conveyance device 9 has a configuration in which traveling table 25 is movable on frame structure 10 in the machine body width direction, and slide base 26 is movable on traveling table 25 in the front-rear direction of the machine body. Lifting and lowering arm 27 movable in the up-down direction is configured at a tip end portion of slide base 26, and robot hand 28 having chucks is assembled at a lower end portion thereof.

In such workpiece automatic conveyance device 9, traveling table 25, slide base 26, and lifting and lowering arm 27 are provided with servo motors, respectively. In the driving of the servo motor in each axial direction, the rotational movement thereof is converted to a linear movement in each direction which is the Z-axis direction, the Y-axis direction, or the X-axis direction via a driving transmission mechanism such as a rack and pinion. Therefore, workpiece W gripped by robot hand 28 is conveyed to a predetermined position by the drive control of the servo motor in each axial direction, and is delivered between the predetermined position and the partner device.

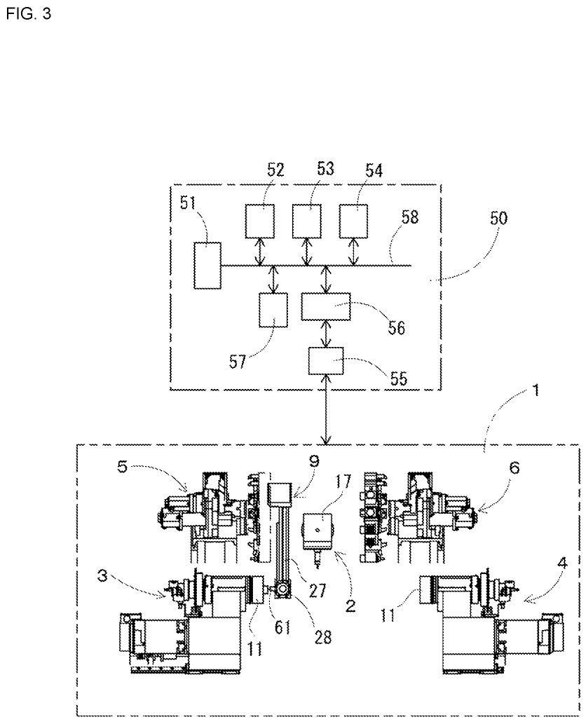

FIG. 3 is a view conceptually illustrating a control system of multifunctional machining machine 1. In control device 50 for driving multifunctional machining machine 1, microprocessor (CPU) 51, ROM 52, RAM 53, non-volatile memory 54, I/O unit 55, and the like are connected via bus line 58. CPU 51 performs overall control of the entire control device, and ROM 52 stores system programs, control parameters, and the like executed by CPU 51, and RAM 53 temporarily stores calculation data and the like.

Volatile memory 54 is information necessary for processing performed by CPU 51, and stores information such as a machining program and a program for performing teaching of multifunctional machining machine 1. Control device 50 is provided with programmable logic controller (PLC) 56 connected to I/O unit 55, and controls the driving sections of various types of machining devices such as tool main spindle device 2 of multifunctional machining machine 1 by a sequence program created in a ladder format. Each function command of the machining program is converted into a necessary signal by the sequence program, and is output from I/O unit 55 to main tool main spindle device 2 or the like.

In multifunctional machining machine 1, the machining of the content according to workpiece W is executed in accordance with the machining program stored in control device 50. Workpiece W to be machined is conveyed from the input stocker to the machining position by workpiece automatic conveyance device 9. Workpiece W gripped by robot hand 28 is moved in the X-axis, the Y-axis and the Z-axis directions by the driving of workpiece automatic conveyance device 9, and is conveyed to first workpiece main spindle device 3 and second workpiece main spindle device 4. After being delivered to main spindle-side chuck 11 of each main spindle device, predetermined machining by first turret device 5 and second turret device 6, or predetermined machining by tool main spindle device 2 is performed.

In workpiece automatic conveyance device 9, the driving of each servo motor in accordance with the conveyance program is stored, and the control to the movement positions of traveling table 25, slide base 26, and lifting and lowering arm 27 is performed. In multifunctional machining machine 1, the teaching is performed so that workpiece automatic conveyance device 9 can accurately deliver workpiece W to the partner device. Therefore, the teaching of robot hand 28 for main spindle-side chuck 11 will be described below using first workpiece main spindle device 3 as the partner device. The teaching for second workpiece main spindle device 4 is also the same.

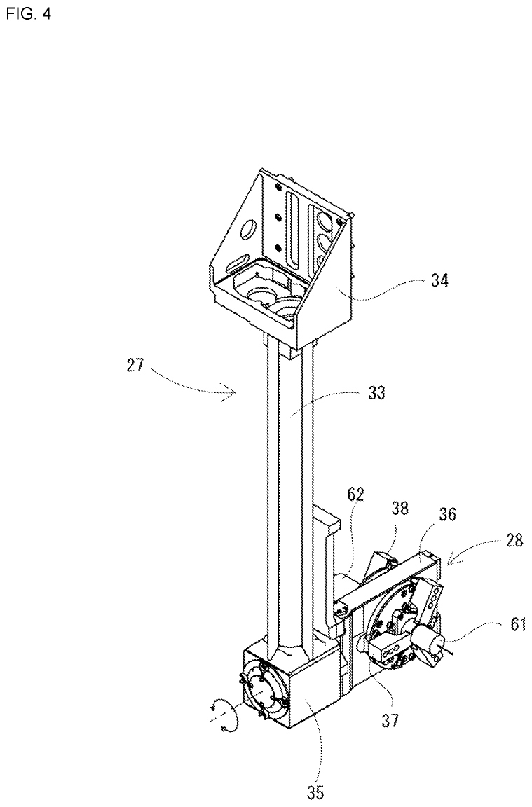

In the teaching system configured in multifunctional machining machine 1, wireless touch probe 61 is used as a measuring instrument, so that a detection signal that is in contact with a target object is transmitted to communication section 57 of control device 50. Here, FIG. 4 is a perspective view illustrating lifting and lowering arm 27 of workpiece automatic conveyance device 9. In lifting and lowering arm 27, connecting section 34 is formed at an upper end portion of arm member 33, and turning motor 35 for adjusting an angle of robot hand 28 is provided at a lower end portion of arm member 33.

In robot hand 28, a pair of robot-side chucks 37 and 38 is configured on both the front and rear surfaces of base 36 which is invertible by 180 degrees by turning motor 35. In performing teaching, by opening and closing chuck claws, a first one of robot-side chucks 37 and 38 grips touch probe 61, and a second one of robot-side chucks 37 and 38 grips master workpiece 62. Touch probe 61 and master workpiece 62 are, for example, provided with a measuring instrument station on the side of the stocker which houses workpiece W, and workpiece W is to be extracted from the station by workpiece automatic conveyance device 9.

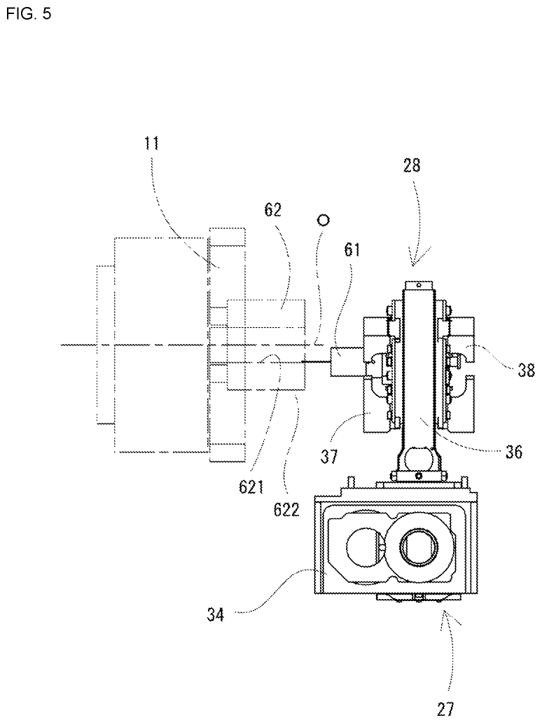

Master workpiece 62 is conveyed to first workpiece main spindle device 3 which is a target for the teaching, and is gripped by main spindle-side chuck 11. After the delivery of master workpiece 62 is performed, robot hand 28 of workpiece automatic conveyance device 9 changes the positions of robot-side chucks 37 and 38 by the driving of turning motor 35, so that touch probe 61 is directed to the partner device. FIG. 3 illustrates a state of teaching in which first workpiece main spindle device 3 is used as a partner device, but FIG. 5 is a view illustrating the state as viewed from the above in the X-axis direction.

In the teaching, the servo motor in each axial direction in workpiece automatic conveyance device 9 is driven, and measurement in which the tip end of touch probe 61 is applied to inner peripheral surface 621 (which may be outer peripheral surface 622) of master workpiece 62 having a cylindrical shape in three directions is performed. When the tip end of the probe contacts master workpiece 62, a wireless contact detection signal is transmitted from touch probe 61 to communication section 57. In control device 50, the rotation angle of the servo motor is obtained in accordance with the reception of the contact detection signal, and the coordinate value of the contact position of the tip end of the probe is calculated from the rotation angle. Center position O of master workpiece 62 is calculated and stored as the coordinate value on an XY-plane orthogonal to the Z-axis.

Center position O of master workpiece 62 gripped by main spindle-side chuck 11 overlaps with the center position of the main spindle of first workpiece main spindle device 3. Therefore, center position O is stored as a delivery position when controlling the delivery of workpiece W. In this manner, the centering is performed by aligning the center of the main spindle of first workpiece main spindle device 3 and the center positions of robot-side chucks 37 and 38 configured in robot hand 28. After the teaching for first workpiece main spindle device 3 is completed, master workpiece 62 is delivered to second workpiece main spindle device 4 by workpiece automatic conveyance device 9. Then, touch probe 61 is contacted in the same manner, the center position of the main spindle is calculated from the coordinate value obtained thereby, and is stored as the delivery position when controlling the delivery of workpiece W.

Incidentally, there may be a case where workpiece automatic conveyance device 9 may come into contact with the machine during the operation of multifunctional machining machine 1, thereby causing a mechanical error in the movement position of robot hand 28. In other words, there may be a case where the value of the three-dimensional coordinate stored by the teaching and the actual movement are misaligned. Even in such a case, the correction is performed in accordance with the correction program. For example, it is performed in a case where workpiece W abuts on a chuck claw of main spindle-side chuck 11, so that a delivery error has occurred. After the above-described teaching is completed, touch probe 61 and master workpiece 62 are returned to the measuring instrument station. Therefore, touch probe 61 or the like is gripped again by robot hand 28 of workpiece automatic conveyance device 9, and the teaching is performed in the same manner to perform the correction of the control value.

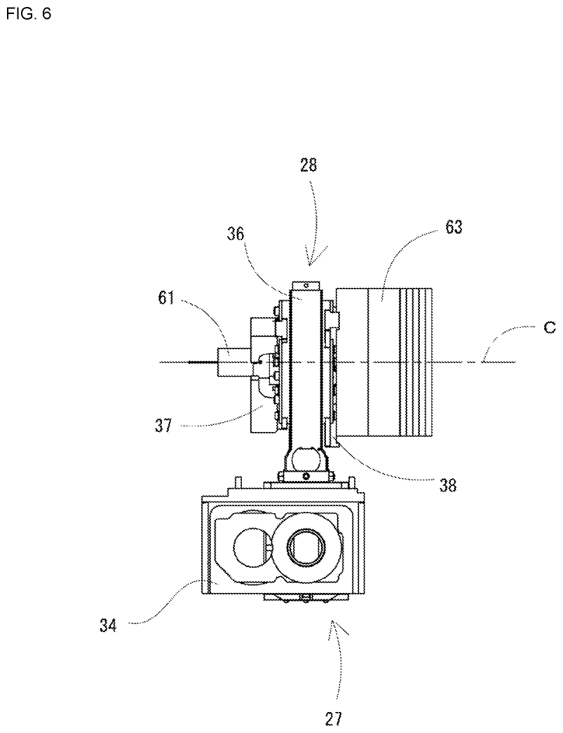

Next, FIG. 6 is a view illustrating a work state of teaching in which a workpiece is gripped on one side as viewed from the above in the X-axis direction. As illustrated in the FIG. 6, in a case where robot hand 28 grips workpiece W only with robot-side chuck 37 (or 38) on one side of base 36, a slight inclination may occur in center line C of robot-side chucks 37 and 38 due to the deviation of the load. Therefore, for example, in a state where measuring workpiece 63 is gripped by robot-side chuck 38 on one side, the teaching in which touch probe 61 is gripped by the opposite robot-side chuck 37 is performed. In this case, multiple measuring workpieces 63 whose weights are changed from 1 kg to 15 kg in units of 1 kg are used.

In workpiece automatic conveyance device 9, the tip end of touch probe 61 while gripping measuring workpiece 63 is applied to inner peripheral surface 621 (which may be outer peripheral surface 622) of master workpiece 62 in three directions in the same manner as in the case illustrated in FIG. 5 described above. The contact detection signal is transmitted from touch probe 61, and in control device 50, center position O of master workpiece 62 is calculated and stored as the coordinate value on the XY-plane orthogonal to the Z-axis. At this time, in a case where an inclination occurs in center line C in accordance with the weight of measuring workpiece 63, a deviation occurs at calculated center position O of master workpiece 62. Therefore, the deviation amount of center position O in the weight change of measuring workpiece 63 is calculated, the value is stored as the correction value, for example, the weight of workpiece W is inputted from the touch panel before machining, and the delivery control subjected to the correction process is performed based on the numerical value.

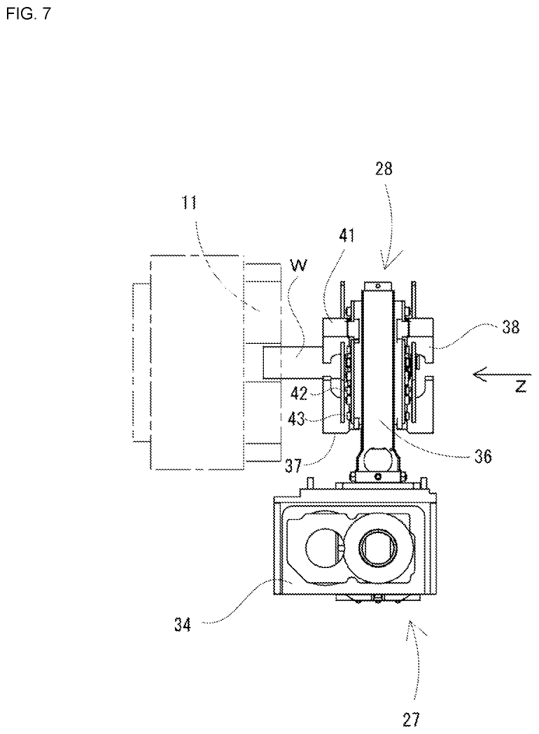

Subsequently, in the teaching using touch probe 61, the coordinate on the XY-plane orthogonal to the main spindle of first workpiece main spindle device 3 (or second workpiece main spindle device 4) is obtained, but the Z-axis direction, that is, the depth of main spindle-side chuck 11 cannot be measured. FIG. 7 is a view illustrating a work state of teaching in the depth direction. In the teaching in the depth direction, workpiece W that is actually to be machined is gripped in advance in the state during machining by main spindle-side chuck 11 of first workpiece main spindle device 3 which is a target for the teaching. Then, robot hand 28 of workpiece automatic conveyance device 9 moves in the Z-axis direction parallel to the main spindle to grip workpiece W.

Robot hand 28 includes a contact detection device for detecting a state in which workpiece W is gripped. Plate-shaped pusher 42 is provided at a base portion of chuck claw 41 and displaced when workpiece W is abutted thereon, and thus seating switch 43 is configured to be pushed. Therefore, in the teaching in the depth direction, robot hand 28 moves in the Z-axis direction parallel to main spindle, seating switch 43 is turned on by contacting workpiece W gripped by main spindle-side chuck 11, and the driving is stopped based on the contact detection signal. In control device 50, the coordinate value of the stop position in the Z-axis direction is calculated based on the rotation angle of the servo motor. Then, the position at which only the amount by which pusher 42 is displaced from the position at which robot hand 28 abuts is retracted is calculated and stored as the delivery position in the depth direction.

According to the present embodiment, automatic measurement is performed on the delivery position by using the contact detection device provided on robot hand 28 such as touch probe 61 and seating switch 43, and the coordinate value for moving robot hand 28 to the delivery position based on the measurement is calculated and stored by the control device. Therefore, a conventional complicated structure is not necessary, and there may be no difference in accuracy or work time depending on the skill level of the operator. In addition, even if a collision occurs during the operation of multifunctional machining machine 1, it is possible to promptly recover the situation by performing the correction teaching.

Although one embodiment of the present disclosure has been described, the present disclosure is not limited to the embodiment, and various modifications can be made without departing from the gist thereof. For example, although a gantry-type robot is exemplified as the workpiece automatic conveyance device in the above embodiment, it may be used in an articulated robot as in the conventional art. In the above embodiment, the main spindle is exemplified as a target for the teaching, but may be another device, for example, may be the teaching for an inspection and measurement device or the like for the machined workpiece. For teaching in this case, for example, a master workpiece is disposed in each device, and measurement using touch probe 61 is performed on the master workpiece. In addition, a machine tool different from multifunctional machining machine 1 may be used as long as the machine tool has a workpiece automatic conveyance device.

### REFERENCE SIGNS LIST

1: multifunctional machining machine, 2: tool main spindle device, 3: first workpiece main spindle device, 4: second workpiece main spindle device, 5: first turret device, 6: second turret device, 8: automatic tool exchanging device, 9: workpiece automatic conveyance device, 11: main spindle-side chuck, 25: traveling table, 26: slide base, 27: lifting and lowering arm, 28: robot hand, 36: base, 37, 38: robot-side chuck, 61: touch probe, 62: master workpiece, 63: measuring workpiece, 50: control device, 57: communication section.

1. A teaching system for a workpiece automatic conveyance device configured to deliver a workpiece gripped by a robot-side chuck configured in a robot hand to a partner device, the teaching system comprising:
a contact detection device provided in the robot hand and configured to detect contact at a predetermined portion with the partner device; and
a control device configured to calculate a position of the robot hand during the contact based on a contact detection signal from the contact detection device.

2. The teaching system for a workpiece automatic conveyance device according to claim 1, wherein the contact detection device is a wireless touch probe gripped by the robot hand, and is configured to bring a tip end of the touch probe into contact with a master workpiece disposed in the partner device by driving the workpiece automatic conveyance device.

3. The teaching system for a workpiece automatic conveyance device according to claim 2, wherein the partner device is a workpiece main spindle device including a main spindle-side chuck configured to grip and rotate the workpiece, the partner device being configured to bring the tip end of the touch probe into contact with the master workpiece having a cylindrical shape gripped by the main spindle-side chuck at several portions and calculate a center position of a main spindle by the control device.

4. The teaching system for a workpiece automatic conveyance device according to claim 2, wherein the robot hand is configured such that the robot-side chuck is configured on both front and rear surfaces of a pivotable base, and while a measuring workpiece is gripped by a first of the robot-side chucks, the robot hand is configured to cause the tip end of the touch probe gripped by a second of robot-side chucks to contact the master workpiece disposed in the partner device.

5. The teaching system for a workpiece automatic conveyance device according to claim 4, wherein the control device is configured to calculate a deviation amount of a center position of a main spindle based on each measurement by the touch probe performed using multiple measuring workpieces having different weights, and perform a delivery control using the deviation amount of the center position due to weight change of the measuring workpieces as a correction value.

6. The teaching system for a workpiece automatic conveyance device according to claim 1, wherein the contact detection device is a seating switch configured in the robot hand and configure to detect a presence or absence of a workpiece gripping state by the robot-side chuck, and the control device is configured to calculate a position of the robot hand by gripping the workpiece disposed on the partner device by the robot-side chuck.
